(19) United States
(12) Patent Application Publication
(10) Pub. No.: US 2026/0212799 A1
(43) Pub. Date: Jul. 23, 2026

(54) DISPLAY DEVICE, DRIVING METHOD OF THE SAME, AND ELECTRONIC DEVICE INCLUDING THE SAME

(71) Applicant: Samsung Display Co., Ltd., Yongin-si (KR)

(72) Inventors: Gyeong-Ub MOON, Yongin-si (KR); Seunghyun MOON, Yongin-si (KR); Kangbin JO, Yongin-si (KR); Goeun CHA, Yongin-si (KR); Boram CHOI, Yongin-si (KR)

(73) Assignee: Samsung Display Co., Ltd., Yongin-si (KR)

(21) Appl. No.: 19/456,677

(22) Filed: Jan. 22, 2026

(30) Foreign Application Priority Data
Jan. 23, 2025 (KR) 10-2025-0010262

(51) Int. Cl. G09G 3/20

(52) U.S. Cl. CPC G09G 3/2092; G09G 2300/0452; G09G 2320/0247; G09G 2320/06; G09G 2330/021

(57) ABSTRACT

A display includes a display panel, including a plurality of pixels, the plurality of pixels including at least one normal pixel corresponding to a first color gamut and at least one supplementary pixel corresponding to a second color gamut different from the first color gamut, a data processing circuit configured to select a driving mode based on a color coordinate for a first pixel among the plurality of pixels in a first frame, and generate a mode selection signal that changes the selected driving mode in response to the color coordinate moving past a first threshold region between the first color gamut and the second color gamut in a second frame adjacent to the first frame, and a data driver configured to drive the plurality of pixels based on the mode selection signal.

### CROSS-REFERENCE TO RELATED APPLICATION

This application claims priority to and the benefit of Korean Patent Application No. 10-2025-0010262 filed with the Korean Patent Office on Jan. 23, 2025, the entire contents of which are incorporated herein by reference.

### BACKGROUND

Among the image quality indicators of a display device, the color gamut is an indicator that shows how closely colors of nature can be represented in the display device to reality.

The color gamut can be represented based on a color coordinate, which is a coordinate value that represents a color perceived by a human as a point on a coordinate system.

As a higher color gamut allows a display device to represent more colors and to represent colors closer to an actual environment, it is utilized as a relevant indicator for reproducing a high-quality image.

To enhance the color gamut, separate pixels having different color regions may be used. However, this method may cause a luminance change within a single frame, resulting in increased flicker.

### SUMMARY

The inventive concepts relate to a display device, a method for driving the display device, and an electronic device including the display device.

Example embodiments of the inventive concepts provide a display device and a method of driving the display device capable of reducing flicker.

A display device according to some example embodiments includes: a display panel, including a plurality of pixels, the plurality of pixels including at least one normal pixel corresponding to a first color gamut and at least one supplementary pixel corresponding to a second color gamut different from the first color gamut, a data processing circuit configured to select a driving mode based on a color coordinate for a first pixel among the plurality of pixels in a first frame, and to generate a mode selection signal that changes the selected driving mode in response to the color coordinate moving past a first threshold region between the first color gamut and the second color gamut in a second frame adjacent to the first frame, and a data driver configured to drive the plurality of pixels based on the mode selection signal.

A method for driving a display device according to some example embodiments includes detecting a first color coordinate for a first pixel among a plurality of pixels in a first frame, the plurality of pixels comprising at least one normal pixel corresponding to a first color gamut and at least one supplementary pixel corresponding to a second color gamut different from the first color gamut, generating a mode selection signal based on the first color coordinate, detecting a second color coordinate for the first pixel in a second frame adjacent to the first frame, determining whether a threshold line between the first color gamut and the second color gamut is between the first color coordinate and the second color coordinate, and generating a mode selection signal based on the second color coordinate based on the threshold line is located between the first color coordinate and the second color coordinate.

A electronic apparatus according to some example embodiments includes a processor configured to control input and output of data in a memory, the memory configured to store image data, a display device configured to display the image data, wherein the display apparatus includes a display panel, including a plurality of pixels, wherein the plurality of pixels includes at least one normal pixel corresponding to a first color gamut and at least one supplementary pixel corresponding to a second color gamut different from the first color gamut, a data processing circuit configured to determine a driving mode based on a first color coordinate in a first frame for a first pixel among the plurality of pixels, determine a second color coordinate in a second frame adjacent to the first frame for the first pixel, determine a final driving mode based on the second color coordinate in response to a threshold line being between the first color coordinate and the second color coordinate, and generate a mode selection signal indicating the determined driving mode, and a data driver configured to drive the plurality of pixels based on the mode selection signal.

### BRIEF DESCRIPTION OF THE DRAWINGS

FIG. 1 is a drawing illustrating a display device according to some example embodiments.

FIG. 2 is a drawing illustrating a display panel according to some example embodiments.

FIG. 3 is a diagram illustrating a data processing circuit according to some example embodiments.

FIG. 4 is a flowchart illustrating an operation method of a display device according to some example embodiments.

FIG. 5 illustrates a color gamut diagram according to some example embodiments

FIG. 6 is a flowchart illustrating an operation method of a display device according to some example embodiments.

FIG. 7 illustrates a color gamut diagram according to some example embodiments.

FIG. 8 is a flowchart illustrating an operation method of a display device according to some example embodiments.

FIG. 9 is a graph illustrating a case where a display panel includes pixels capable of displaying one color gamut.

FIG. 10 is a graph illustrating a case where a display panel includes a first pixel capable of displaying a first color gamut and a second pixel capable of displaying a second color gamut.

FIG. 11 is a graph illustrating a case where the driving mode is changed as the color coordinates for the pixel move past a threshold line when the display panel includes a first pixel capable of displaying a first color gamut and a second pixel capable of displaying a second color gamut.

FIG. 12 and FIG. 13 are graphs showing the number of color gamut conversions of the display device.

FIG. 14 and FIG. 15 are graphs showing the driving voltage of the display device.

FIG. 16 shows a block diagram on an electronic device according to some example embodiments.

FIG. 17 to FIG. 19 show schematic diagrams of an electronic device according to some example embodiments.

### DETAILED DESCRIPTION

Some example embodiments of the inventive concepts will be described more fully hereinafter with reference to the accompanying drawings so that those skilled in the art could easily implement the example embodiments. The example embodiments may be modified in various ways, all without departing from the spirit or scope of the inventive concepts.

In order to clearly describe the inventive concepts, parts or portions that are irrelevant to the description are omitted, and identical or similar constituent elements throughout the specification are denoted by the same reference numerals.

Unless explicitly stated to the contrary, the word “comprise” and variations such as “comprises” and “comprising” should be understood to imply the inclusion of stated elements but not the exclusion of any other elements.

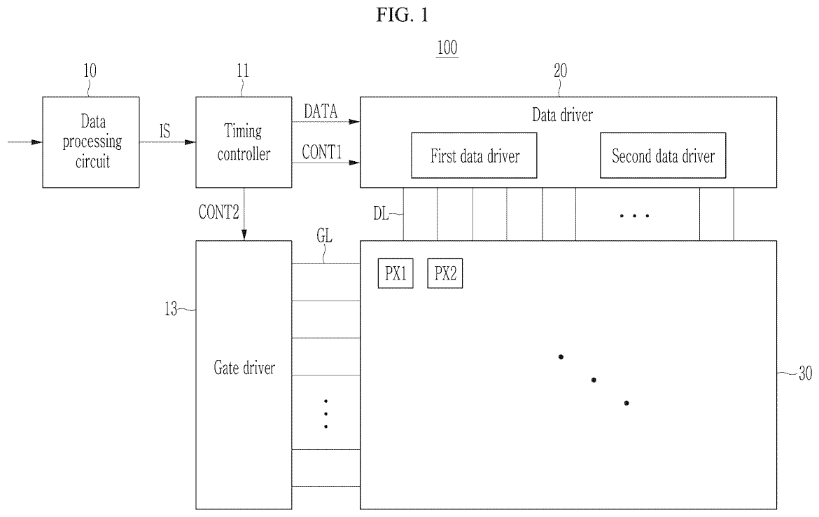

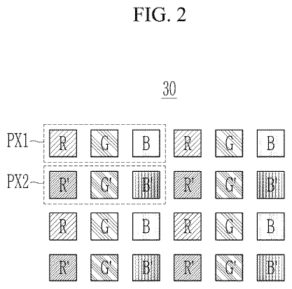

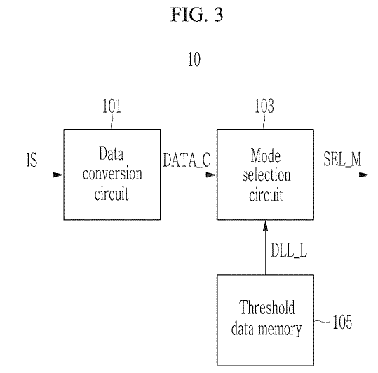

FIG. 1 is a drawing illustrating a display device according to some example embodiments. FIG. 2 is a drawing illustrating a display panel according to some example embodiments. FIG. 3 is a diagram illustrating a data processing circuit according to some example embodiments.

The display device 100 may perform a display operation. The display operation may be an operation for displaying an image corresponding to an image signal received from the host.

In some example embodiments, the display device 100 includes a data processing circuit 10, a timing controller 11, a gate driver 13, a data driver 20, and/or a display panel 30.

The display panel 30 may display an image to the user according to an image signal received from the host.

The display panel 30 may be one of the display devices that receives an electrically transmitted image signal and displays a two-dimensional image, such as a thin film transistor-liquid crystal display TFT-LCD, an organic light emitting diode OLED display, a field emission display, and/or a plasma display panel PDP. In some example embodiments, there may be one or more display panels 30.

The display panel 30 may include a plurality of signal lines, such as a plurality of gate lines GL and/or a plurality of data lines DL. The display panel 30 may include a plurality of pixels PX1, PX2 connected to a plurality of signal lines and arranged in a matrix form. The display panel 30 may display an image based on a data signal received from a data driver 20 and a gate driving signal received from a gate driver 13.

In some example embodiments, the display panel 30 may include at least one first pixel PX1 and/or at least one second pixel PX2.

FIG. 2 is a drawing illustrating a display panel 30 according to some example embodiments.

As illustrated in FIG. 2, the display panel 30 may include a plurality of pixels PX. In some example embodiments, each, or one or more, of the plurality of pixels PX may be a first pixel PX1 or a second pixel PX2. The first pixel PX1 and the second pixel PX2 may be arranged alternately within the display panel 30. The present disclosure is not limited to the arrangement of the first pixel PX1 and the second pixel PX2 illustrated in FIG. 2, and the first pixel PX1 and the second pixel PX2 may be arranged in various ways.

The first pixel PX1 and the second pixel PX2 may have different displayable color gamuts. Color gamut refers to the color space region that may be displayed in an image across the entire range of light. A color gamut may be defined by the plurality of grid points within a two-dimensional color space. For example, the range of a color gamut may be defined by grid points including a red point R, a green point G, a blue point B, a cyan point C, a magenta point M, a yellow point Y, and/or a white point W. A combination of these grid points may generally form a triangular region.

Each, or one or more, grid point may be defined by a coordinate value, and the coordinate value may be composed of an x-axis coordinate value and/or a y-axis coordinate value. Here, the values for the red component, green component, and/or blue component of the image data, e.g., the color, may be determined corresponding to the x-axis coordinate value and/or the y-axis coordinate value of the grid point.

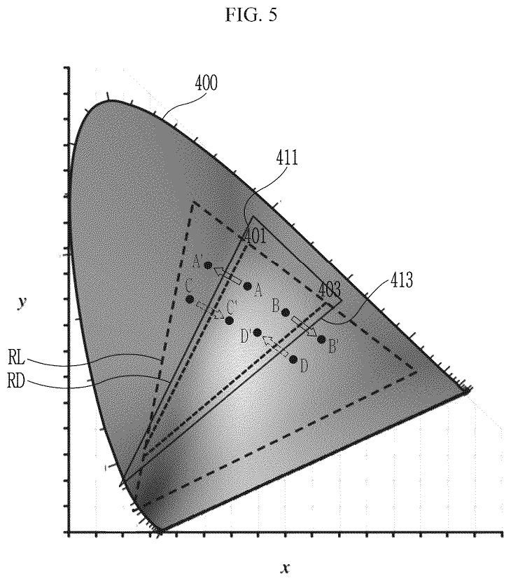

In some example embodiments, the first pixel PX1 may be a normal pixel corresponding to the first color gamut. The second pixel PX2 may be a supplementary pixel corresponding to the second color gamut. For example, the first color gamut may correspond to the region that may display normal RGB. For example, the second color gamut may correspond to a region that may display R′G′B′, which is lighter than normal RGB. In some example embodiments, the color gamut displayable by the first pixel PX1 may be larger than that displayable by the second pixel PX2. The color gamut corresponding to each, or one or more, of the first pixel PX1 and the second pixel PX2 will be described later with reference to FIG. 5.

In FIG. 1, the first pixel PX1 and the second pixel PX2 are illustrated as being connected to the data line DL and the gate line GL, but the connection structure of the signal lines of the pixels PX1, PX2 of the display device according to some example embodiments is not limited thereto. For example, various signal lines may be additionally connected depending on the circuit structure of the pixel PX1, PX2.

The data processing circuit 10 may detect color coordinates to be displayed by each, or one or more, of a plurality of pixels PX based on an image signal received from the host. In some example embodiments, the data processing circuit 10 may determine the driving mode of the display device 100. For example, the data processing circuit 10 may determine the driving mode based on the input image signal IS input to the display device 100. The data processing circuit 10 may generate a driving mode selection signal SEL_M that controls the timing controller 11 based on the determined driving mode.

Referring to FIG. 3, the data processing circuit 10 may include a data conversion circuit 101, a threshold data memory 105, and/or a mode selection circuit 103.

The data conversion circuit 101 may receive an input image signal IS and generate color data DATA_C based on the input image signal IS. Color data DATA_C may be color coordinates corresponding to each, or one or more, of the plurality of pixels PX in the image.

The data conversion circuit 101 may detect color coordinates corresponding to each, or one or more, of a plurality of pixels PX based on a preset, or alternately given, color system. In some example embodiments, the color system may include YUV/YCbCr, Lab, HSV (Hue saturation value), etc. However, the inventive concepts are not limited thereto and may include various color systems.

The threshold data memory 105 may include critical data DATA_L required or sufficient, for the data processing circuit 10 to determine the driving mode of the display device 100. For example, the threshold data memory 105 may be referred to as a graphics RAM (Random Access Memory), a frame buffer, etc. In some example embodiments, the threshold data memory 105 may include volatile memory such as dynamic random access memory DRAM, static random access memory SRAM, and/or nonvolatile memory such as ROM, flash memory, resistive random access memory ReRAM, and/or magnetic random access memory MRAM.

The threshold data memory 105 may include data for a first color gamut corresponding to a first pixel PX1 and/or data for a second color gamut corresponding to a second pixel PX2. For example, the threshold data memory 105 may include a first look up table corresponding to the first color gamut. The threshold data memory 105 may include a second lookup table corresponding to the second color gamut.

In some example embodiments, the threshold data memory 105 may further include data for at least one threshold region within a region where the first gamut and the second gamut overlap. The threshold region may be a portion of the region where the first and second color gamuts overlap. In some example embodiments, the threshold data memory 105 may further include data for threshold lines located within the threshold region. For example, the threshold line may be a line positioned a predetermined, or alternately given, distance away from an overlapping line where the first gamut and the second gamut overlap. In some example embodiments, the threshold region and threshold line may be preset (or alternatively given) in consideration of reduction of power consumption and flicker phenomenon of the display device 100 according to the characteristics of the display panel 30 in the display device 100 (e.g., the material of the display panel).

The mode selection circuit 103 may determine the driving mode of the display device 100. In some example embodiments, the mode selection circuit 103 may receive color data DATA_C from the data conversion circuit 101. The mode selection circuit 103 may receive critical data DATA_L from the threshold data memory 105. In some example embodiments, the mode selection circuit 103 may generate a mode selection signal SEL_M based on color data DATA_C and/or threshold data DATA_L. The mode selection signal SEL_M may be a signal that controls the data driver 20 to drive at least one of the first pixel PX1 and/or the second pixel PX2. In some example embodiments, the mode selection signal SEL_M may include data for a corresponding lookup table to indicate a color gamut corresponding to the image signal IS.

For example, the first driving mode may be a mode for driving the first pixel PX1. The second driving mode may be a mode for driving the second pixel PX2. The third driving mode may be a mode for driving the first pixel PX1 and the second pixel PX2.

In some example embodiments, the data processing circuit 10 may receive an input image signal IS in which color coordinates for any pixel among a plurality of pixels PX move from a first color coordinate to a second color coordinate. The data conversion circuit 101 may determine first color data indicating first color coordinates and/or second color data indicating second color coordinates. The mode selection circuit 103 may determine a driving mode corresponding to each, or one or more, of the first color data and/or the second color data based on the threshold data DATA_L. For example, the mode selection circuit 103 may determine that the display device 100 operates in the first driving mode when the color coordinates are included in the first color gamut. For example, the mode selection circuit 103 may determine that the display device 100 operates in the second driving mode when the color coordinates are included in the second color gamut. For example, for the input image signal IS, the mode selection circuit 103 may change the driving mode so that the display device 100 operates in the first driving mode and then operates in the second driving mode. In some example embodiments, when the second color coordinates are included in the same first color gamut as the first color coordinates, the mode selection circuit 103 may determine a driving mode so that the display device 100 operates in the first driving mode.

In some example embodiments, the mode selection circuit 103 may determine the drive mode based on whether the color coordinates for any pixel move past a preset (or alternatively given) threshold region and/or threshold line. The mode selection circuit 103 may change the driving mode when the color coordinates for the pixel move past the threshold line from the first color coordinates to the second color coordinates located in a different color gamut.

For example, the mode selection circuit 103 may determine that the display device 100 operates in the first driving mode when the color coordinates are included in the first color gamut, and may determine that the display device 100 operates in the second driving mode when the color coordinates are included in the second color gamut. For example, the mode selection circuit 103 may change the display device 100 from operating in the first driving mode to operating in the second driving mode when a threshold line is located between the second color coordinates and the first color coordinates, e.g., when the color coordinates change from the first color coordinates to the second color coordinates by passing the threshold line. For example, when the first color coordinate is included in the first color gamut and the second color coordinate is included in the second color gamut, but no threshold line is located between the first color coordinate and the second color coordinate, that is, when the color coordinate changes from the first color coordinate to the second color coordinate without passing the threshold line, the mode selection circuit 103 may maintain the driving mode of the display device 100 in the first driving mode. For example, the mode selection circuit 103 may maintain the driving mode of the display device 100 in the previous driving mode when the change in color coordinates does not pass through the threshold region or threshold line.

In some example embodiments, the mode selection circuit 103 may determine the driving mode based on whether the color coordinates for any pixel are located within a threshold region. For example, the mode selection circuit 103 may change the driving mode to the third driving mode when the color coordinates for the pixel move from the first color coordinates to the second color coordinates located in a different color gamut, passing the threshold line, and then moving from the second color coordinates to the third color coordinates, repeatedly within a certain period of time.

For example, the mode selection circuit 103 may determine that the display device 100 operates in the first driving mode when the color coordinates are included in the first color gamut, and may determine that the display device 100 operates in the second driving mode when the second color coordinates are included in the second color gamut. For example, the mode selection circuit 103 may determine that the display device 100 operates in the third driving mode when the color coordinates are included within the threshold region. The mode selection circuit 103 may change the driving mode of the display device 100 to the third driving mode when the color coordinates are located within a threshold region between the first color gamut and the second color gamut.

The mode selection circuit 103 may generate a mode selection signal SEL_M indicating a determined driving mode and transmit the mode selection signal SEL_M to the timing controller 11.

The timing controller 11 may control the driving timing of the display device 100. The timing controller 11 may perform various image processing for image signals received from the host, such as changing the format of image data and reducing power consumption. The timing controller 11 may transmit digital video data of an input image received from the host to the data driver 20. The timing controller 11 controls the operation timing of the data driver 20 and/or the gate driver 13 by using signals such as a vertical synchronization signal, a horizontal synchronization signal, a data enable signal, and/or a main clock received from the host in synchronization with digital video data.

In some example embodiments, the timing controller 11 may control the driving timing of the display device 100 based on a mode selection signal SEL_M received from the data processing circuit 10. In some example embodiments, the timing controller 11 may control the driving timing of the display device 100 based on a vertical synchronization signal, a horizontal synchronization signal, a data enable signal, a main clock signal, etc. received from the host in synchronization with the image signal.

The timing controller 11 may generate a data control signal CONT1 based on an image signal received from the host. The timing controller 11 may generate image data DATA based on an input image signal IS. The timing controller 11 may transmit a data control signal CONT1 and/or image data DATA to the data driver 20.

In some example embodiments, the timing controller 11 may generate a gate control signal CONT2. The timing controller 11 may transmit a gate control signal CONT2 to the gate driver 13.

The gate driver 13 may drive a plurality of gate lines GL of the display panel 30 based on a gate control signal CONT2 received from the timing controller 11. The gate driver 13 may provide a gate voltage to each, or one or more, of a plurality of gate lines GL based on a gate control signal CONT2. For example, the gate driver 13 may provide pulses of gate-on voltage to the corresponding gate line GL during the corresponding driving period based on the gate control signal CONT2. The gate driver 13 may output a gate control signal CONT2 to the display panel 30 through a plurality of gate lines GL.

The data driver 20 may receive a data control signal CONT1 and/or image data DATA from the timing controller 11. In some example embodiments, the data driver 20 may receive image data DATA in data units corresponding to a first pixel PX1 and/or a second pixel PX2 included in one horizontal line of the display panel 30. Image data DATA may include grayscale information corresponding to each pixel PX to display an input image signal IS on a display panel 30. The data driver 20 may process image data DATA in synchronization with a clock signal received from the timing controller 11.

The data driver 20 may be connected to a plurality of data lines DL. The data driver 20 may convert image data DATA into a data signal in the form of an analog signal based on a data control signal CONT1 and output the data signal to the display panel 30 through a plurality of data lines DL. A data driver 20 may implement one frame by outputting a data signal corresponding to each, or one or more, of a plurality of data lines DL. In some example embodiments, the data driver 20 may output a plurality of data signals DATA to the display panel 30 in horizontal line units.

In some example embodiments, the data driver 20 may include a first data driver 21 and/or a second data driver 23.

The first data driver 21 may be connected to the first pixel PX1. The first data driver 21 may convert image data DATA into a data signal corresponding to the first pixel PX1 based on a data control signal CONT1. In the first driving mode, the first data driver 21 may drive the first pixel PX1.

The second data driver 23 may be connected to the second pixel PX2. The second data driver 23 may convert image data DATA into a data signal corresponding to the second pixel PX2 based on a data control signal CONT1. In the second driving mode, the second data driver 23 may drive the second pixel PX2.

In some example embodiments, in the third driving mode, the first data driver 21 and the second data driver 23 may simultaneously drive the first pixel PX1 and the second pixel PX2, respectively.

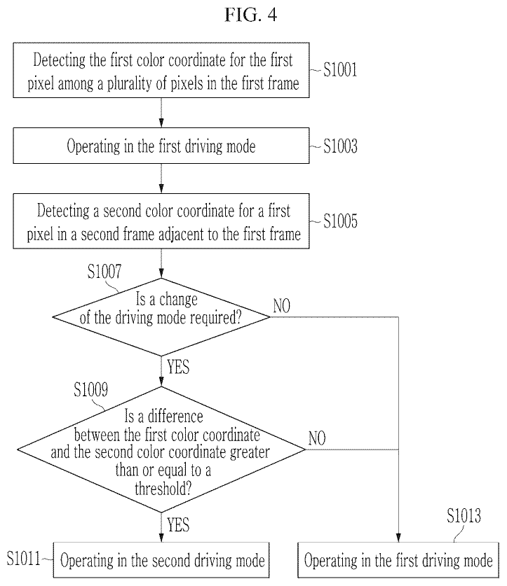

FIG. 4 is a flowchart illustrating an operation method of a display device according to some example embodiments. FIG. 5 illustrates a color gamut diagram according to some example embodiments.

First, in S1001, the data processing circuit 10 detects the first color coordinate for the first pixel among a plurality of pixels in the first frame.

The data processing circuit 10 may receive an input image signal IS. In some example embodiments, the data processing circuit 10 may detect the first color coordinates based on a preset (or alternatively given) color scheme corresponding to the display device 100. The data processing circuit 10 may determine that the first color coordinates are included in the first color gamut. The data processing circuit 10 may generate a mode selection signal SEL_M that controls the data driver to drive the first pixel corresponding to the first color gamut. In some example embodiments, a first data driver 21 may drive a first pixel PX1. For example, the data processing circuit 10 may generate a mode selection signal SEL_M indicating the first driving mode.

In S1003, the display device 100 operates in the first driving mode.

The display device 100 may operate in a first driving mode in which the first data driver 21 drives the first pixel PX1.

In S1005, in a second frame adjacent to the first frame, the display device 100 may detect a second color coordinate for the first pixel.

In S1007, the data processing circuit 10 determines whether a change in driving mode is necessary.

In some example embodiments, the data processing circuit 10 may determine whether a change in the driving mode is necessary based on whether the color gamut included in the color coordinates corresponding to the first pixel has changed.

The data processing circuit 10 may determine the color gamut in which the second color coordinates for the first pixel is included in the second frame. If the data processing circuit 10 determines that the second color coordinate is included in the same color gamut as a first color coordinate for the first pixel in a first frame, it may determine that a change in the driving mode is not necessary.

Referring to FIG. 5, the color expression region 400 may include a first color gamut RL and/or a second color gamut RD. The first color gamut RL may be region that the first pixel PX1 may display. The second color gamut RD may be region that a second pixel PX2 may display.

As illustrated in FIG. 5, the region of the second color gamut RL may be larger than the region of the first color gamut RD. This may mean that the first pixel PX1 may display more colors than the second pixel PX2. In some example embodiments, some regions of the first color gamut RL and some regions of the second color gamut RD may overlap.

The first DLL (Deep to Light Limit, DLL) threshold line 401 and/or the second DLL threshold line 403 may be lines preset (or alternatively given) within the threshold region. In some example embodiments, the first DLL threshold line 401 and/or the second DLL threshold line 403 may be threshold lines that are applied when the first color coordinate moves from the first gamut RL to the second gamut RD.

The first LDL (Light to Deep Limit, LDL) threshold line 411 and/or the second LDL threshold line 413 may be lines preset (or alternatively given) within the threshold region. In some example embodiments, the first LDL threshold line 411 and/or the second LDL threshold line 413 may be threshold lines that are applied when the first color coordinate moves from the second gamut RD to the first gamut RL. The first DLL threshold line 401, the second DLL threshold line 403, the first LDL threshold line 411, and/or the second LDL threshold line 413 may be preset (or alternatively given) lines in consideration of reduction of power consumption and/or flicker phenomenon according to panel characteristics of the display device 100 (e.g., the material of the display panel).

For example, the position of the color coordinate of any pixel among a plurality of pixels PX may move from the first point A to the first′ point A′.

In some example embodiments, the data processing circuit 10 may determine to change the driving mode (e.g., determine that a change in the driving mode is necessary) when it is determined that the second color coordinate is included in a second color gamut different from the first color gamut of the first color coordinate for the first pixel in the first frame. At this time, the data processing circuit 10 may determine that the first point A is included in the second color gamut RD. The data processing circuit 10 may determine that the first point A′ is included in the first color gamut RL.

Accordingly, the data processing circuit 10 may determine to change the driving mode (e.g., determine that a change in driving mode is necessary).

In S1013, if it is determined not to change the driving mode (e.g., determined that a change in driving mode is not necessary), operation is performed in the first driving mode.

In S1009, if the data processing circuit 10 determines to change the driving mode (e.g., determines that a change in the driving mode is necessary), the data processing circuit 10 determines whether a threshold line is located between the first color coordinate and the second color coordinate.

In some example embodiments, the data processing circuit 10 may determine whether a threshold line is located between a first color coordinate included in a first color gamut and a second color coordinate included in a second color gamut. For example, the data processing circuit 10 may determine whether the second color coordinate is located beyond the threshold region from the first color coordinate. The threshold region may be a portion of the region where the first and second color gamuts overlap.

Referring again to FIG. 5, the data processing circuit 10 may determine that a threshold line is located between the first color coordinate and the second color coordinate when the first′ point A′ moves past the first LDL threshold line 411 from the first point A.

At S1013, if it is determined that a threshold line is not located between the first color coordinate and the second color coordinate, operation is performed in the first driving mode.

If the data processing circuit 10 determines that a threshold line is not located between the first color coordinates and the second color coordinates, the display device 100 may be maintained to operate in the first driving mode.

When a threshold line is located between the first color coordinate and the second color coordinate, operation is performed in the second driving mode S1011.

For example, the data processing circuit 10 may determine the driving mode based on the second color coordinates.

In the above, some example embodiments where the position of the color coordinate of the first pixel moves from the first point A to the first′ point A′ is described.

In some example embodiments, when the position of the color coordinate of the first pixel among the plurality of pixels PX moves from the second point B to the second′ point B′, the data processing circuit 10 may determine to change the driving mode (e.g., determine that a change in the driving mode is necessary). The data processing circuit 10 may determine that a threshold line is located between the first color coordinate and the second color coordinate when the second′ point B′ moves past the second LDL threshold line 413 from the second point B.

When the position of the color coordinate of the first pixel among the plurality of pixels PX moves from the third point C to the third′ point C′, the data processing circuit 10 may determine to change the driving mode (e.g., determine that a change in the driving mode is necessary). The data processing circuit 10 may determine that the threshold line is located between the first color coordinate and the second color coordinate when the third′ point C′ moves past the first DLL threshold line 401 from the third point C.

When the position of the color coordinate of the first pixel among the plurality of pixels PX moves from the fourth point D to the fourth′ point D′, the data processing circuit 10 may determine to change the driving mode (e.g., determine that a change in the driving mode is necessary). The data processing circuit 10 may determine that a threshold line is located between the first color coordinate and the second color coordinate when the fourth′ point D′ moves past the second DLL threshold line 403 from the fourth point D.

According to some example embodiments, as the data processing circuit 10 determines whether to change the driving mode based on the threshold line, an image may be displayed by the display device 100 with a higher color gamut while decreasing the flicker phenomenon.

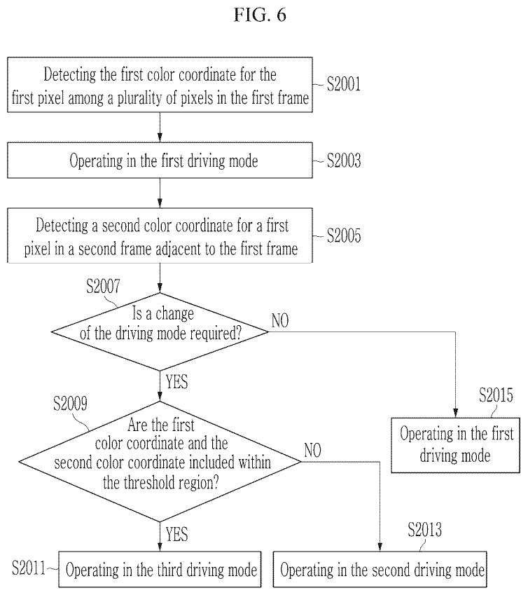

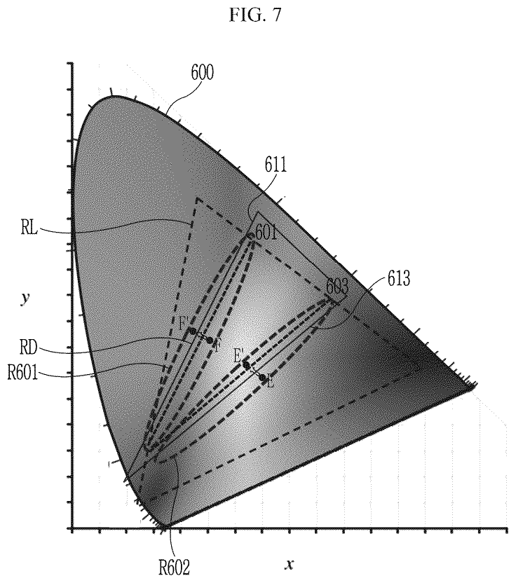

FIG. 6 is a flowchart illustrating an operation method of a display device according to some example embodiments. FIG. 7 illustrates a color gamut diagram according to some example embodiments.

First, in S2001, the data processing circuit 10 detects the first color coordinate for the first pixel among a plurality of pixels in the first frame.

Referring to FIG. 7, the color expression region 400 may include a first color gamut RL and/or a second color gamut RD. The first color gamut RL may be region that the first pixel PX1 may display. The second color gamut RD may be region that a second pixel PX2 may display.

The first DLL threshold line 601 and/or the second DLL threshold line 603 may be preset (or alternatively given) lines within the threshold region. In some example embodiments, the first DLL threshold line 601 and/or the second DLL threshold line 603 may be threshold lines that are applied when the first color coordinate moves from the first gamut RD to the second gamut RL.

The first LDL threshold line 611 and/or the second LDL threshold line 613 may be preset (or alternatively given) lines within the threshold region. In some example embodiments, the first LDL threshold line 611 and/or the second LDL threshold line 613 may be threshold lines that are applied when the first color coordinate moves from the second gamut RL to the first gamut RD.

The first DLL threshold line 601, the second DLL threshold line 603, the first LDL threshold line 611, and/or the second LDL threshold line 613 may be preset (or alternatively given) lines in consideration of reduction of power consumption and/or flicker phenomenon according to panel characteristics of the display device 100 (e.g., the material of the display panel).

The data processing circuit 10 may determine that the first point E is included in the first color gamut.

In S2003, the display device 100 operates in the first driving mode.

Since the data processing circuit 10 determines that the first point E is included in the first color gamut, and may generate a mode selection signal SEL_M corresponding to the first driving mode so that the display device 100 operates in the first driving mode corresponding to the first color gamut.

In S2005, the data processing circuit 10 may detect a second color coordinate for the first pixel in a second frame adjacent to the first frame.

The data processing circuit 10 may determine that the first′ point E′ is included in the second color gamut.

The data processing circuit 10 may determine whether to change the driving mode (e.g., whether a change in driving mode is necessary) at S2007.

In some example embodiments, the data processing circuit 10 may determine to change the driving mode (e.g., determine that a change in the driving mode is necessary) when it is determined that the second color coordinate is included in a second color gamut different from the first color gamut of the first color coordinate for the first pixel in the first frame. As illustrated in FIG. 7, the data processing circuit 10 may determine to change the driving mode (e.g., determine that a change in the driving mode is necessary) because the first pixel has moved from the first point E included in the first color gamut to the first′ point E′ included in the second color gamut.

In S2015, if the data processing circuit 10 determines not to change the driving mode (e.g., determine that a change in driving mode is not necessary), operation is performed in the first driving mode.

In S2009, if the data processing circuit 10 determines to change the driving mode (e.g., determines that a change in the driving mode is necessary), it is determined whether the first color coordinate and the second color coordinate are included within the threshold region.

In some example embodiments, the data processing circuit 10 may determine whether the first color coordinate and/or the second color coordinate are included within a threshold region. As shown in FIG. 7, the first threshold region R601 and/or the second threshold region R602 may be preset (or alternatively given). The first threshold region R601 and/or the second threshold region R602 may be located between the first color gamut RD and the second color gamut RL. In some example embodiments, the first threshold region R601 may include a first DLL threshold line 601 and/or a first LDL threshold line 611. In some example embodiments, the second threshold region R602 may include a second DLL threshold line 603 and/or a second LDL threshold line 613.

In some example embodiments, the first threshold region R601 and/or the second threshold region R602 may be preset (or alternatively given) regions in consideration of reduction in power consumption and/or flicker phenomenon according to panel characteristics of the display device 100 (e.g., the material of the display panel).

The data processing circuit 10 may determine that both the first point E and the first′ point E′ are included in the second threshold region R602. If the first color coordinate and the second color coordinate are included within the threshold region, operation is performed in the third driving mode S2011.

Referring to FIG. 7, since the data processing circuit 10 determines that both the first point E and the first′ point E′ are included in the second threshold region R602, the display device 100 may determine to operate in the third driving mode. In some example embodiments, the data processing circuit 10 may generate a mode selection signal SEL_M that controls the display device 100 to operate in a third driving mode that drives both the first pixel PX1 corresponding to the first color gamut and the second pixel PX2 corresponding to the second color gamut.

If the first color coordinate and the second color coordinate are not included within the threshold region, operation is performed in the second driving mode S2013.

The data processing circuit 10 may generate a mode selection signal SEL_M that controls the display device 100 to operate in a second driving mode corresponding to the second color coordinates.

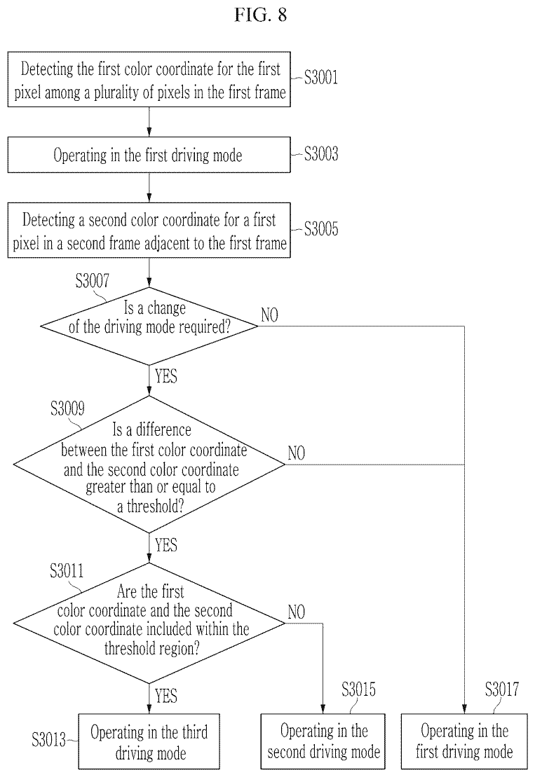

FIG. 8 is a flowchart illustrating an operation method of a display device according to some example embodiments.

First, at S3001, the data processing circuit 10 detects the first color coordinate for the first pixel among a plurality of pixels in the first frame.

At S3003, the display device 100 operates in the first driving mode.

In S3005, the data processing circuit 10 may detect a second color coordinate for the first pixel in a second frame adjacent to the first frame.

At S3007, the data processing circuit 10 may determine whether a change in driving mode is necessary.

In S3017, if it is determined that a change in driving mode is not necessary, operation is performed in the first driving mode.

In S3009, if the data processing circuit 10 determines to change the driving mode (e.g., determines that a change in the driving mode is necessary), it is determined whether a threshold line is located between the first color coordinate and the second color coordinate.

At S3017, if a threshold line is not located between the first color coordinate and the second color coordinate, operation is performed in the first driving mode.

At S3011, if a threshold line is located between the first color coordinate and the second color coordinate, it is determined whether the first color coordinate and the second color coordinate are included within the threshold region.

At S3013, if the first color coordinate and the second color coordinate are included within the threshold region, operation is performed in the third driving mode.

At S3015, if the first color coordinate and the second color coordinate are not included within the threshold region, operation is performed in the second driving mode.

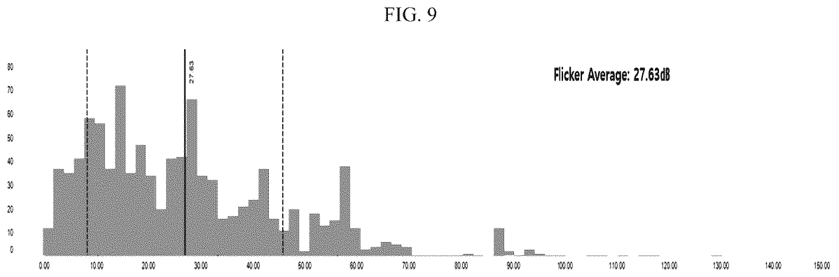

FIGS. 9 to 11 are graphs showing the number of pixels according to the flicker intensity per pixel of a display device according to some example embodiments.

In FIGS. 9 to 11, the x-axis represents the flicker intensity per pixel, and the y-axis represents the number of pixels having the corresponding flicker intensity. Here, the flicker intensity may be a numerical value of the change in brightness that occurs on the display panel, for example, based on 60 Hz.

FIG. 9 is a graph illustrating a case where a display panel includes pixels capable of displaying one color gamut. As shown in FIG. 9, the flicker average may be 27.63 dB.

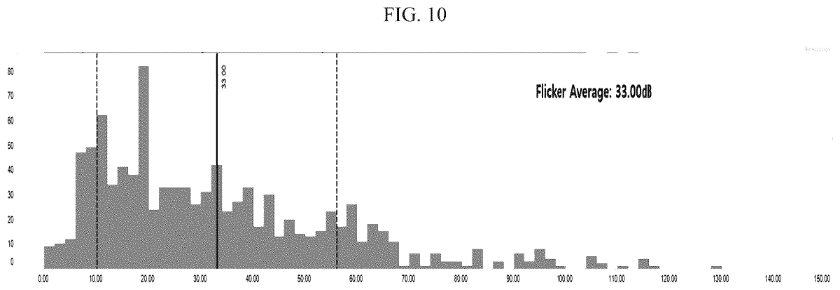

FIG. 10 is a graph illustrating a case where a display panel includes a first pixel capable of displaying a first color gamut and a second pixel capable of displaying a second color gamut. As shown in FIG. 10, the flicker average may be 33 dB.

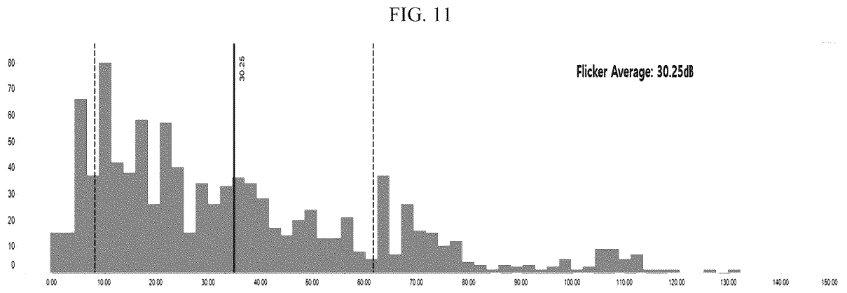

FIG. 11 is a graph illustrating a case where the driving mode is changed as the color coordinates for the pixel move past a preset (or alternatively given) threshold line when the display panel includes a first pixel capable of displaying a first color gamut and a second pixel capable of displaying a second color gamut. As shown in FIG. 11, the flicker average may be 30.25 dB.

As illustrated in FIGS. 9 to 11, the number of pixels having strong intensity flicker may be reduced by changing the driving mode as the color coordinates move past a preset (or alternatively given) threshold line, rather than simply changing the driving mode as the color gamut in which the color coordinates for the pixel are located changes.

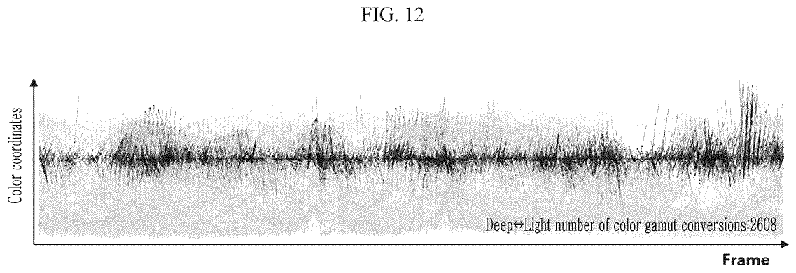

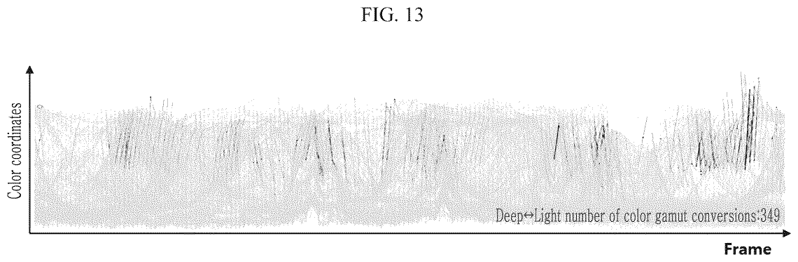

FIGS. 12 and 13 are graphs showing the number of color gamut conversions of the display device.

In FIGS. 12 and 13, the x-axis may represent the number of frames, and the y-axis may represent the color coordinates output in the corresponding frame for any pixel in the display device.

As illustrated in FIG. 12, when a display panel includes a first pixel capable of displaying a first color gamut and a second pixel capable of displaying a second color gamut, the first pixel may switch between the first color gamut and the second color gamut 2608 times in any section.

As illustrated in FIG. 13, when the display panel includes a first pixel capable of displaying a first color gamut and a second pixel capable of displaying a second color gamut, when the driving mode is changed as the color coordinates for the pixel move past a preset (or alternatively given) threshold line, the first pixel may switch between the first color gamut and the second color gamut 349 times in an arbitrary section.

For example, the number of times the driving mode is changed may be reduced as the color coordinates for the pixel move past a preset (or alternatively given) threshold line. Since flickering may occur due to changes in the color gamut that may be displayed for each, or one or more, driving mode when changing the driving mode, the number of times the driving mode is changed may decrease the number of times flickering occurs.

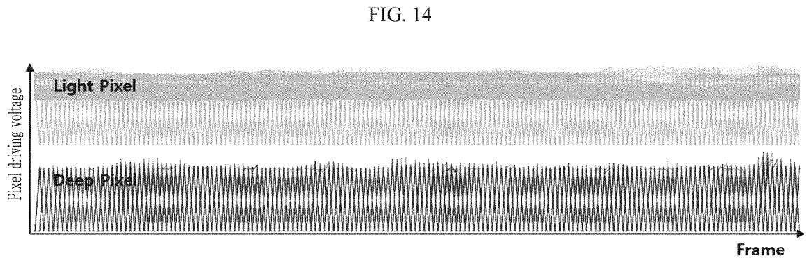

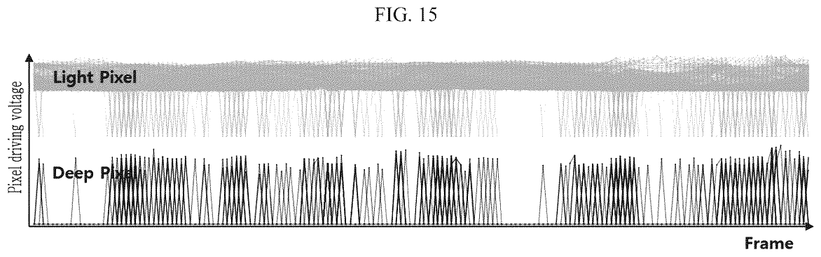

FIGS. 14 and 15 are graphs showing the driving voltage of the display device.

In FIGS. 14 and 15, the x-axis may represent a frame, and the y-axis may represent a driving voltage for driving a pixel in the corresponding frame.

As illustrated in FIG. 14, when the display panel includes a first pixel capable of displaying a first color gamut and a second pixel capable of displaying a second color gamut, each, or one or more, of the driving voltages applied to the first pixel and the second pixel may vary significantly.

As illustrated in FIG. 15, when the display panel includes a first pixel capable of displaying a first color gamut and a second pixel capable of displaying a second color gamut, and the driving mode is changed as the color coordinates for the pixels move past a preset (or alternatively given) threshold line, each, or one or more, of the driving voltages applied to the first pixel and the second pixel may fluctuate less than in FIG. 14. According to some example embodiments, since the fluctuation of the driving voltage applied to the first pixel and the second pixel may be reduced, the power consumption of the display device may be reduced.

The display device according to some example embodiments may be applied to various electronic devices. An electronic device according to some example embodiments includes the display device described above, and may further include a module or device having additional functions in addition to the display device.

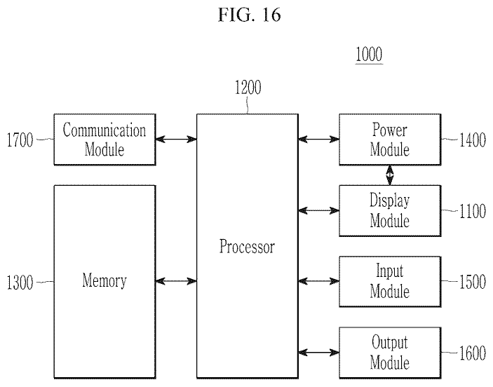

FIG. 16 shows a block diagram of an electronic device according some example embodiments.

Referring to FIG. 16, an electronic device 1000 according to some example embodiments may include a display module 1100, a processor 1200, a memory 1300, and a power module 1400.

The processor 1200 may include at least one of a central processing unit CPU, an application processor AP, a graphic processing unit GPU, a communication processor CP, an image signal processor ISP, and/or a controller. In some example embodiments, the processor 1200 may control input/output of data stored in the memory 1300.

The memory 1300 may store data information necessary, or sufficient, for the operation of the processor 1200 and/or the display module 1100. In some example embodiments, the memory 1300 may store image data for image information output by the display module 1100. When the processor 1200 executes an application stored in the memory 1300, an image data signal and/or an input control signal is transmitted to the display module 1100, and the display module 1100 may process the received signal and output image information through a display screen. For example, the display module 1100 may receive image data from the memory 1300 and output the received image data.

The display module 1100 may be a display device 100 described with reference to FIGS. 1 to 15.

The power module 1400 may include a power supply module, such as a power adapter and/or a battery device, and/or a power conversion module that converts power supplied by the power supply module to generate power required, or sufficient, for the operation of the electronic device 1000.

The electronic device 1000 may further include an input module 1500, a non-image output module 1600, and/or a communication module 1700.

The input module 1500 may provide input information to the processor 1200 and/or the display module 1100. The input module 1500 may include various sensor modules as well as physical buttons, a keyboard, and/or a microphone. Examples of sensor modules may include touch sensors, pressure sensors, distance sensors, position sensors, digitizers, motion recognition sensors, camera sensors, photodetectors, photoelectric conversion sensors, temperature sensors, as well as biosensors such as blood pressure sensors, blood sugar sensors, electrocardiogram sensors, and/or heart rate sensors.

The non-image output module 1600 may receive information other than video from the processor 1200 and provide it to the user. Examples of non-image output modules 1600 include an audio module, a haptic module, a light-emitting module, etc., and may include other functional modules unique to the electronic device (e.g., a cooling module of a refrigerator, etc.).

The communication module 1700 is a module responsible for transmitting and/or receiving information between the electronic device 1000 and an external device, and may include a receiving unit and/or a transmitting unit. The communication module 1700 may include various wireless communication modules such as a mobile communication module, a Wi-Fi module, a Bluetooth module, and/or various wired communication modules.

At least one of the components of the above-described electronic device 1000 may be included in the display device according to the above-described example embodiments. Additionally, some of the individual modules functionally included within a module may be included within the display device, while others may be provided separately from the display device. For example, the display device may include a display module 1100, and/or the processor 1200, memory 1300, and/or power module 1400 may be provided in the form of other devices within the electronic device 1000 other than the display device.

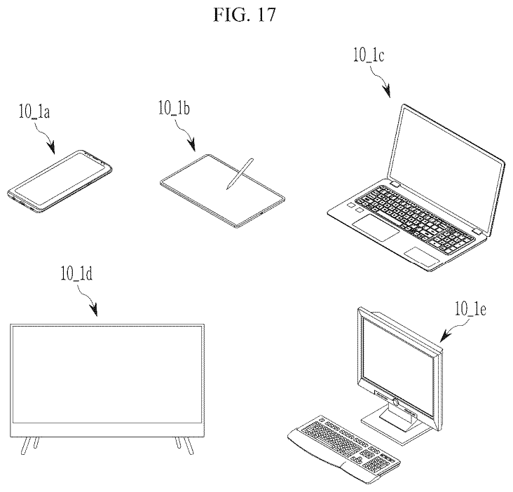

FIGS. 17 to 19 are schematic diagrams of electronic devices according to some example embodiments. FIGS. 17 to 19 illustrate examples of various electronic devices to which display devices according to some example embodiments are applied.

FIG. 17 shows examples of electronic devices, including a smartphone 10_1a, a tablet PC 10_1b, a laptop 10_1c, a TV 10_1d, and a desk monitor 10_1e.

The smartphone 10_1a may include an input module such as a touch sensor and/or a communication module in addition to the display module 1100. The smartphone 10_1a may process information received through a communication module and/or other input module and display the information through a display module of the display device.

In the case of tablet PCs 10_1b, laptops 10_1c, TVs 10_1d, and desk monitors 10_1e, they include a display module and/or an input module similar to the smartphone 10_1a, and in some cases, they may further include a communication module.

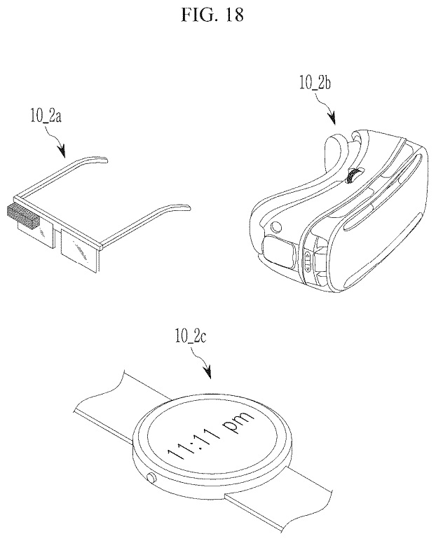

FIG. 18 shows an example in which an electronic device including a display module is applied to a wearable electronic device. The wearable electronic device may be a smart glasses 10_2a, a head mounted display 10_2b, a smart watch 10_2c, etc.

Smart glasses 10_2a and/or head mounted displays 10_2b may include a display module that emits a display image and/or a reflector that reflects the emitted display image and provides it to the user's eyes, thereby providing a virtual reality or augmented reality screen to the user.

The smartwatch 10_2c includes a biometric sensor as an input device and may provide biometric information recognized by the biometric sensor to the user through a display module.

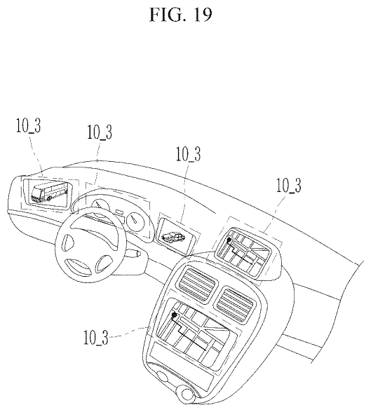

FIG. 19 shows an example where an electronic device including a display module is applied to a vehicle. For example, the electronic device 10_3 may be applied to a dashboard, center fascia, etc. of a car, and/or may be applied to a CID (Center Information Display) placed on a dashboard of a car and/or a room mirror display replacing a side mirror.

Although not illustrated, electronic devices to which display devices according to some example embodiments are applied may include not only devices that mainly display screens, such as billboards, electronic boards, and/or game consoles, but also various home appliances that display information through display modules, such as refrigerators, washing machines, dryers, air conditioners, and/or robot vacuum cleaners. In addition, if the display module has a function of transmitting light, it may be applied to electronic devices such as smart windows and/or transparent display devices that display a background and a display image together. The types of electronic devices according to some example embodiments are not limited to those described above, and application of various other electronic devices not specifically described may also be possible.

The display device according to some example embodiments may be applied to various electronic devices. An electronic device according to some example embodiments includes the display device described above, and/or may further include a module or device having additional functions in addition to the display device.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Although some example embodiments of the inventive concepts have been described in detail above, the scope of the inventive concepts are not limited thereto, and various modifications and improvements made by those skilled in the art using the basic concept of the inventive concepts defined in the following claims also fall within the scope of the inventive concepts.

What is claimed:

1. A display device comprising:
a display panel, including a plurality of pixels, the plurality of pixels including at least one normal pixel corresponding to a first color gamut and at least one supplementary pixel corresponding to a second color gamut different from the first color gamut;
a data processing circuit configured to
select a driving mode based on a color coordinate for a first pixel among the plurality of pixels in a first frame, and
generate a mode selection signal that changes the selected driving mode in response to the color coordinate moving past a first threshold region between the first color gamut and the second color gamut in a second frame adjacent to the first frame; and
a data driver configured to drive the plurality of pixels based on the mode selection signal.

2. The display device of claim 1, wherein the data processing circuit comprises:
a data conversion circuit configured to generate color data indicating a color coordinate for each pixel of the plurality of pixels;
a threshold data memory comprising threshold data for the first color gamut, the second color gamut, and the first threshold region; and
a mode selection circuit configured to generate the mode selection signal based on the threshold data and the color data.

3. The display device of claim 2, wherein
the data driver comprises:
a first data driver connected to the at least one normal pixel and configured to drive the at least one normal pixel, and
a second data driver connected to the at least one supplementary pixel and configured to drive the at least one supplementary pixel.

4. The display device of claim 3, wherein the mode selection circuit is configured to generate:
a first mode selection signal that controls the first data driver in response to the color coordinate being in the first color gamut, and
a second mode selection signal that controls the second data driver in response to the color coordinate being in the second color gamut.

5. The display device of claim 1, wherein
the first threshold region is a partial region within an overlapping region where the first color gamut and the second color gamut overlap.

6. The display device of claim 5, wherein
the first threshold region is based on a material of the display panel.

7. The display device of claim 5, wherein
the first threshold region comprises a first threshold line,
the data processing circuit includes a mode selection circuit is configured to
generate a first mode selection signal in the first frame in response to the color coordinate being at a first color coordinate within the first color gamut in the first frame, and
generate a second mode selection signal in the second frame in response to the color coordinate being at a second color coordinate within the second color gamut in the second frame and the first threshold line being between the first color coordinate and the second color coordinate,
the first mode selection signal controls the data driver to drive the at least one normal pixel, and
the second mode selection signal controls the data driver to drive the at least one supplementary pixel.

8. The display device of claim 7, wherein
the first threshold region comprises a second threshold line, and
the mode selection circuit is configured to
generate the second mode selection signal in the first frame in response to the color coordinate being at the second color coordinate in the first frame, and
generate the first mode selection signal in the second frame in response to the color coordinate being located at the first color coordinate in the second frame and the second threshold line being between the first color coordinate and the second color coordinate.

9. The display device of claim 8, wherein
the first threshold line and the second threshold line are different.

10. The display device of claim 4, wherein
the mode selection circuit is further configured to generate a third mode selection signal that controls the first data driver and the second data driver in response to the color coordinate being in the first threshold region.

11. The display device of claim 10, wherein
the first threshold region is a partial region within an overlapping region where the first color gamut and the second color gamut overlap.

12. The display device of claim 11, wherein
the mode selection circuit is configured to generate the third mode selection signal in response to the color coordinate being located within the first threshold region in the first frame and the second frame.

13. A method for driving a display device, the method comprising:
detecting a first color coordinate for a first pixel among a plurality of pixels in a first frame, the plurality of pixels comprising at least one normal pixel corresponding to a first color gamut and at least one supplementary pixel corresponding to a second color gamut different from the first color gamut;
generating a mode selection signal based on the first color coordinate;
detecting a second color coordinate for the first pixel in a second frame adjacent to the first frame;
determining whether a threshold line between the first color gamut and the second color gamut is between the first color coordinate and the second color coordinate; and
generating a mode selection signal based on the second color coordinate based on whether the threshold line is located between the first color coordinate and the second color coordinate.

14. The method for driving a display device of claim 13, wherein
the generating the mode selection signal comprises:
generating a first mode selection signal that drives the at least one normal pixel in response to the first color coordinate for the first pixel being in the first color gamut, and
generating a second mode selection signal that drives the at least one supplementary pixel in response to the first color coordinate for the first pixel being in the second color gamut.

15. The method for driving a display device of claim 14, wherein
the determining whether the threshold line is between the first color coordinate and the second color coordinate comprises:
determining whether a first threshold line is within a first threshold region, the first threshold region being a partial region within an overlapping region where the first color gamut and the second color gamut overlap, between the first color coordinate and the second color coordinate.

16. The method for driving a display device of claim 15, further comprising:
determining whether the first color coordinate and the second color coordinate are included within the first threshold region in response to the threshold line being between the first color coordinate and the second color coordinate, and
generating the mode selection signal based on the second color coordinate in response to determining that the first color coordinate and the second color coordinate are not included within the first threshold region.

17. The method for driving a display device of claim 16, further comprising:
generating a third mode selection signal that drives the at least one normal pixel and the at least one supplementary pixel in response to determining that the first color coordinate and the second color coordinate are included within the first threshold region.

18. An electronic apparatus comprising:
a processor configured to control input and output of data in a memory;
the memory configured to store image data;
a display device configured to display the image data, wherein the display device comprises:
a display panel, comprising a plurality of pixels, wherein the plurality of pixels includes at least one normal pixel corresponding to a first color gamut and at least one supplementary pixel corresponding to a second color gamut different from the first color gamut,
a data processing circuit configured to
determine a driving mode based on a first color coordinate in a first frame for a first pixel among the plurality of pixels,
determine a second color coordinate in a second frame adjacent to the first frame for the first pixel,
determine a final driving mode based on the second color coordinate in response to a threshold line being between the first color coordinate and the second color coordinate, and
generate a mode selection signal indicating the determined driving mode, and
a data driver configured to drive the plurality of pixels based on the mode selection signal.

19. The electronic apparatus of claim 18, wherein
the threshold line is located within a threshold region, the threshold region being a partial region within an overlapping region where the first color gamut and the second color gamut overlap, and
the threshold region is based on a material of the display panel.

20. The electronic apparatus of claim 19, wherein
the data processing circuit is configured to generate the mode selection signal to indicate:
a first driving mode that drives the at least one normal pixel in response to the first color coordinate for the first pixel being in the first color gamut,
a second driving mode that drives the at least one supplementary pixel in response to the first color coordinate for the first pixel being in the second color gamut, and
a third driving mode that drives the at least one normal pixel and the at least one supplementary pixel in response to the first color coordinate for the first pixel being in the threshold region.
